(19) United States
(12) Patent Application Publication
(10) Pub. No.: US 2010/0077959 A1
(43) Pub. Date: Apr. 1, 2010

(54) AIRLESS SPRAY GUN VIRTUAL COATINGS APPLICATION SYSTEM

(75) Inventors: Jeremiah G. Treloar, Waterloo, IA (US); Christopher A. Lampe, Cedar Falls, IA (US); Jason M. Ebensberger, Cedar Falls, IA (US); Michael J. Bolick, Waterloo, IA (US); John Whiting, Denver, IA (US); Richard J. Klein, II, Waterloo, IA (US); Eric C. Peterson, San Antonio, TX (US); Chad J. Zalkin, San Antonio, TX (US); Warren C. Couvillion, JR., San Antonio, TX (US); Stephen R. Gray, San Antonio, TX (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: UNIVERSITY OF NORTHERN IOWA RESEARCH FOUNDATION, Cedar Falls, IA (US)

(21) Appl. No.: 12/239,963

(22) Filed: Sep. 29, 2008

(51) Int. Cl. B05C 11/00

(52) U.S. Cl. 118/681; 118/679; 118/682

(57) ABSTRACT

A virtual coatings application system realistically simulates airless spray painting. The system generally includes a display screen on which is defined a virtual surface that is intended to be virtually painted or coated by the user. The user operates the instrumented airless spray gun controller which is instrumented with a tracking device and an electronic on/off switch for the trigger. The system also has a motion tracking system that tracks the position and orientation of the airless spray gun controller with respect to the virtual surface defined on the display screen. Simulation software generates virtual spray pattern data in response to the setup parameters and the position and orientation of the airless spray gun controller with respect to the virtual surface. Virtual spray pattern images are displayed in real time on the display screen in accordance with the accumulation of virtual spray pattern data at each location on the virtual surface. The primary purpose of the system is to enhance training. In addition to providing virtual painting of a part, the system also provides for virtual practice sessions in which the user can test setup parameters by painting virtual practice paper.

### FIELD OF THE INVENTION

The invention relates to the use of computer simulation and virtual reality systems for training and analyzing proper spraying techniques. More specifically, the invention relates to improvements that facilitate accurate simulation of airless spray gun technology. The invention also relates to other features that allow the virtual reality experience to more closely simulate that of an actual spray painting experience within a typical spray painting environment.

### BACKGROUND OF THE INVENTION

The use of computer simulation and virtual reality systems to foster practice and training of proper paint spraying techniques is known in the art. For example, the assignee of the present application has filed several patent applications relating to such systems, all of which are incorporated herein by reference: application Ser. No. 11/372,714 filed on Mar. 10, 2006, and application Ser. No. 11/539,352 filed on Oct. 6, 2006 both entitled “Virtual Coatings Application System”, and application Ser. No. 11/563,842 filed on Nov. 28, 2006, entitled “Virtual Coatings Application System with Structured Training and Remote Instructor Capabilities”. These patents describe systems that enable the user to view and interact with real spray application equipment while simulating the application of the coating (e.g. paint) on a virtual surface. Because the application of the coating is simulated, no material is expended and harmful emissions and waste are not produced. These computer based systems also include performance monitoring and analysis software that allow a student or an instructor to monitor the student's progress.

To date, most of the development work has focused on simulating spray painting with high volume, low pressure (HVLP) spray guns. The simulation models for HVLP spray guns, while quite realistic for HVLP spray guns, do not accurately or realistically simulate airless spray gun technology. With airless spray guns, paint fluid pressure is used to propel the paint from the spray gun tip without the use of compressed air. Normally, in the field, the paint is maintained at a pressure which is adjustable by a hydraulic pump located on the floor. The trigger for a typical airless spray gun is an on/off trigger with no intermediate settings. The paint pattern expelled from an airless spray gun is quite linear under normal operating conditions.

Airless spray guns are configured so that nozzle tips with different sizes can be attached to the spray gun. Tips are sized (e.g. 0912) according to orifice size (e.g. a 9 mm opening), and the length of the typical pattern in inches (e.g. 12 inches), at the ideal stand off distance and pressure. The size of the orifice helps to control the thickness of the paint on the part. There are a large number of tip sizes available in the art. As a general rule, most tip sizes can be used with low or medium viscosity paints; however, high viscosity paints with a syrup-like consistency require large orifices. High viscosity coatings typically require a fluid pressure of 4,000 psi or higher.

When low or medium viscosity paints are used, tails can form in the pattern of the paint as it hits the workpiece if the paint does not atomize appropriately. For low viscosity paints, it has been found that tails work themselves out normally at 1500 to 2000 psi at reasonable standoff distances. For medium viscosity paint, tails are normally worked out at about 2500 psi. However, the characteristics of the pattern for each tip size are quite different. Also, if the fluid pressure is too high for a particular tip, the pattern and thickness of the paint may not distribute evenly. For example, if a technician wants to paint quickly, they should use a large orifice with a larger pattern rather than increasing paint pressure beyond a normal range. In addition, the standoff distance of the spray gun from the surface being painted is important as well. If the spray gun is placed too close to the surface, the paint will hit the surface too fast and will cause running and uneven application.

Many spray painting booths, and training facilities, are equipped with non-absorbing practice paper. Using practice paper, the painter in the booth can practice with various tip sizes and fluid pressure settings to ensure that the setup is proper for the viscosity of the paint being used before coating of the part begins.

### SUMMARY OF THE INVENTION

An object of the present invention is to provide a virtual coatings application system that realistically models the operation of an airless spray gun, and also emulates the typical setup necessary for airless spray guns. The invention as described herein provides several features contributing to improvements in this respect.

Another object of the invention is to provide a virtual reality training system for an airless spray gun that not only realistically simulates the spray painting experience for the user but also allows performance monitoring and feedback, as described in the above incorporated patent applications.

In one aspect, the invention is a virtual coatings application system that is designed to realistically simulate the use of an airless spray gun. In this regard, the preferred system generally includes a display screen on which is defined a virtual surface that is intended to be virtually painted or coated by the user. The user operates a spray gun controller simulating an airless spray gun which outputs an electrical signal representing whether the trigger on the airless spray gun controller is in an on position or in an off position. Simulation software in a computer, preferably a desktop or laptop PC, is configured to prompt a user to input training session setup parameters such as tip size, paint fluid pressure, and/or paint viscosity. The system also has a motion tracking system, as described in the incorporated co-pending patent applications, that tracks the position and orientation of the airless spray gun controller with respect to the virtual surface defined on the display screen. Simulation software generates virtual spray pattern data in response to the training session setup parameters and the position and orientation data received from the tracking system. A virtual spray pattern image is displayed in real time on the display screen in accordance with the accumulation of virtual spray pattern data at each location on the virtual surface. The simulation model for the airless spray gun results in a spray pattern and density that varies as a function of time in response to the standoff distance and the angular orientation of the airless spray gun controller with respect to the virtual surface.

In the preferred embodiment, the total build thickness rate which is distributed over the resulting pattern on the virtual surface is determined as a function of selected tip size, paint fluid pressure and the sensed standoff distance of the airless spray gun controller from the virtual surface on the screen display. The software simulates coverage patterns and build thickness via a model based on empirical data derived from actual spray patterns for airless spray guns having a variety of tip sizes and fluid pressure settings. Even though there is a wide variety of tip settings available, the preferred model contains build thickness data based on various fluid pressure settings for the following tip sizes: 0908, 0912, 1110, 1112, 1114, 1308, 1312, 1314, 1510, 1514, 1712, and 1914. In addition, it has been found that transfer efficiency varies with standoff distance. Therefore, empirical data for the model also includes and uses this information to determine the total paint flow distributed over the virtual spray pattern per unit time.

It has also been found that the shape of the spray pattern from an airless spray gun can be separated into a primary pattern which is substantially vertical if the spray gun is held in the vertical position, as well as an elliptical pattern that begins to form as the standoff distance is reduced. In accordance with these findings, the preferred system models the primary pattern via a series of data points representing: 1) linear distance along the pattern, 2) the pattern width at that point; and 3) the pattern thickness along the centerline at that point. Pattern thickness is assumed to fall off linearly as the pattern extends away from the centerline. The ends of the pattern are assumed to have a semicircular shape over which the thickness falls off linearly as well. When appropriate, the model for the primary pattern includes a plurality of data points defining one or two tails in the primary pattern. The overall length of the pattern is adjusted per the instantaneous standoff distance, as is the thickness applied per unit time per pixel. The data for the primary patterns is collected for several standoff distances, and interpolation and normalization are used to calculate values between the empirically derived data points.

In addition, the model superimposes an elliptical pattern over the primary pattern in order to model the effect of standoff distance on pattern shape. The intensity and size of the elliptical pattern are defined from empirical data at various standoff distances. The purpose of the elliptical pattern is to simulate degradation of the primary pattern due to rapid buildup as the standoff distance of the airless spray gun to the virtual surface is reduced. Therefore, the elliptical model data trends by increasing the intensity of the elliptical pattern relative to the primary pattern as the standoff distance is reduced. Typically, at large standoff distances, such as 20 inches, the elliptical pattern is non-existent, thereby rendering the display pattern to be completely dependent on the primary pattern.

It has been found that this system accurately and realistically simulates the use of actual airless spray guns. In addition, with this technique, it is possible to calculate coverage and density for a first side of the pattern from the model and then use a mirror image for the other side of the pattern. This technique helps to reduce calculation requirements, thereby facilitating system responsiveness.

As mentioned, the invention as described can be used as a stand alone system, or can also be used as a module incorporating features of the above-incorporated co-pending patent applications.

As in the above incorporated co-pending patent applications, the preferred tracking system is a hybrid inertial and ultrasonic, six degree of freedom tracking system. Preferably, a combined inertial and ultrasonic sensor is mounted on the airless spray gun controller to sense linear and angular momentum as well as ultrasonic signals generated by a series of ultrasonic transmitters mounted above or adjacent a virtual work space in front of the display screen. The preferred tracking system provides accurate six degree of freedom (x, y, z, pitch, yaw and roll) tracking data, that is well suited to avoid interference that can tend to corrupt data with other types of tracking systems. The on/off signal from the spray gun controller is preferably sent to the computer via a USB connection for use by simulation software and/or graphics engine software. The cable can be housed within a hose to further simulate a paint supply hose which would typically be attached to an airless spray gun.

In another aspect of the preferred embodiment of the invention, the system has the graphical user interface that allows either an instructor or a student to select system setup parameters such as spray gun tip size, viscosity of the finish, finish color and minimum and maximum mil thickness for the virtual target. If a lesson is selected, the performance criteria are preferably set by the instructor in order for the student to pass the lesson. The student, however, sets the fluid pressure for the airless spray gun controller from the graphical user interface, preferably using a slide. Alternatively, an icon can be accessed on the display screen which allows the student to adjust fluid pressure with the airless spray gun controller, preferably in increments of 100 psi.

The preferred embodiment of the invention also provides for practice sessions with virtual practice paper. In particular, the system includes part image data for the image of a part to be displayed on the screen. The image of the part serves as the target for the student during normal operation, such as when taking a lesson or in free play mode. In accordance with this aspect of the invention, the software also provides image data for virtual practice paper which can be displayed on the display screen and serve as a target for the student as an alternative to virtually painting a part. Virtual practice paper may be helpful for the student during airless spray gun setup, for example, to adjust the fluid pressure and standoff distance in order to obtain a desired coverage pattern without tails or excessive buildup. If a lesson plan is used, it is normally desirable to allow the student to access the virtual practice paper before taking the lesson. On the other hand, it is desirable to allow the student to access the virtual practice paper any time during free play or lesson mode. The use of the virtual practice paper feature is especially important in applications using airless spray guns because system setup can have a tremendous effect on spraying performance. The use of virtual practice paper is, however, also useful for other spray painting simulations which are not intended to simulate an airless spray gun such as a system simulating an HVLP spray gun.

Other features and advantages of the invention should be apparent to those skilled in the art upon reviewing the following drawings and description thereof.

### BRIEF DESCRIPTION OF THE DRAWINGS

FIG. 1 is a schematic drawing illustrating a person using a virtual coatings application system having an airless spray gun controller in accordance with the preferred embodiment of the invention.

FIG. 2 is a schematic drawing illustrating the preferred embodiment of an airless spray gun controller used in accordance with one aspect of the invention.

FIG. 3 is a schematic view illustrating a tip fitting being replaced on an airless spray gun controller.

FIG. 4 is a block diagram showing the elements of data flow of a virtual reality coatings application system in accordance with the preferred embodiment of the invention.

FIG. 4a is a diagram illustrating the software architecture of the preferred system.

FIG. 5 illustrates a lesson administration screen on the graphical user interface for a preferred embodiment of the invention.

FIG. 6 illustrates a lesson-in-progress screen on the graphical user interface in a preferred embodiment of the invention.

FIG. 7 illustrates a two dimensional image of non-absorbent practice paper as the virtual surface on the display screen, as in accordance with the preferred embodiment of the invention.

FIG. 8 depicts a two dimensional part image as the virtual surface on the display screen, wherein overspray is depicted in a color distinct from the color of the virtual paint sprayed onto the image of the part.

FIG. 9 shows a popup menu displayed on the display screen on which the virtual surface is also displayed showing an assortment of icons accessible by the user in accordance with the preferred embodiment of the invention.

FIG. 10 is a schematic drawing illustrating typical spray pattern characterizations for airless spray guns, as well as exemplary y-axis measurements used for modeling spray patterns from empirical data.

FIG. 11 illustrates the depiction of a virtually painted surface when shown in accumulation mode.

### DETAILED DESCRIPTION OF THE INVENTION

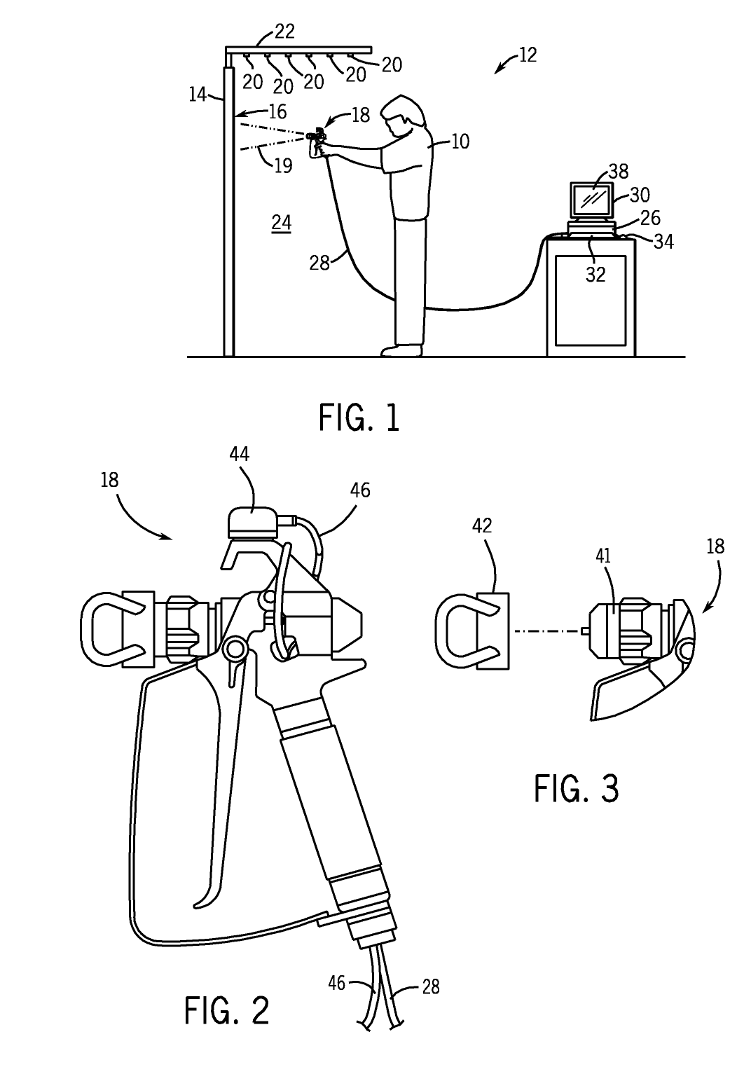

FIG. 1 shows a person 10 using a virtual coatings application system 12 configured in accordance with a preferred embodiment of the invention. The virtual coatings application system 12 is intended to be used to teach painting techniques with an airless spray gun by allowing the user 10 to repeat the painting process an unlimited amount of times without any part preparation or paint mixing. The system 12 helps painters learn the best approach for painting a part, and can be used to screen potential painters for general skills and abilities. By using the virtual coatings application system 12 as part of the normal training routine, a user can gain valuable experience and sharpen their painting technique without even preparing a part for painting, mixing paint, or cleaning up equipment. The system 12 works best for beginner painters but can also be used by experienced painters to hone their skills.

The virtual coatings application system 12 includes a display screen 14, preferably on a large projection screen television although other types of display screens can be used, such as a head-mounted display described in co-pending, incorporated application Ser. No. 11/539,352. A 72 inch screen (measured on the diagonal) provides a suitable amount of virtual work area, although an 86 inch screen is preferred. The system 12 defines a virtual surface on the front surface 16 of the display screen 14. The user 10 is holding an airless spray gun controller 18, and is operating the controller 18 to apply a virtual coating or layered coatings to the virtual surface 16. FIG. 1 shows a virtual spray 19 being applied to the virtual surface 16, although the virtual spray 19 is imaginary.

The position and orientation of the airless spray gun controller 18 is monitored using a tracking system, preferably a six degree of freedom tracking system that monitors translation in the x, y and z direction, as well as the pitch, yaw and roll. The preferred tracking system is a hybrid inertial and ultrasonic tracking system, as described in more detail in co-pending patent application Ser. No. 11/372,714, although many aspects of the invention may be implemented using other types of tracking technologies. The preferred inertial and ultrasonic tracking system is desired because it minimizes electrical interference present with other types of commercially available tracking systems. FIG. 1 schematically depicts an arrangement of ultrasonic transmitters 20 which are mounted to a frame 22 extending over a space 24 in front of the virtual surface 16. The space 24 in front of the virtual surface 16 is referred to herein as the virtual workspace 24.

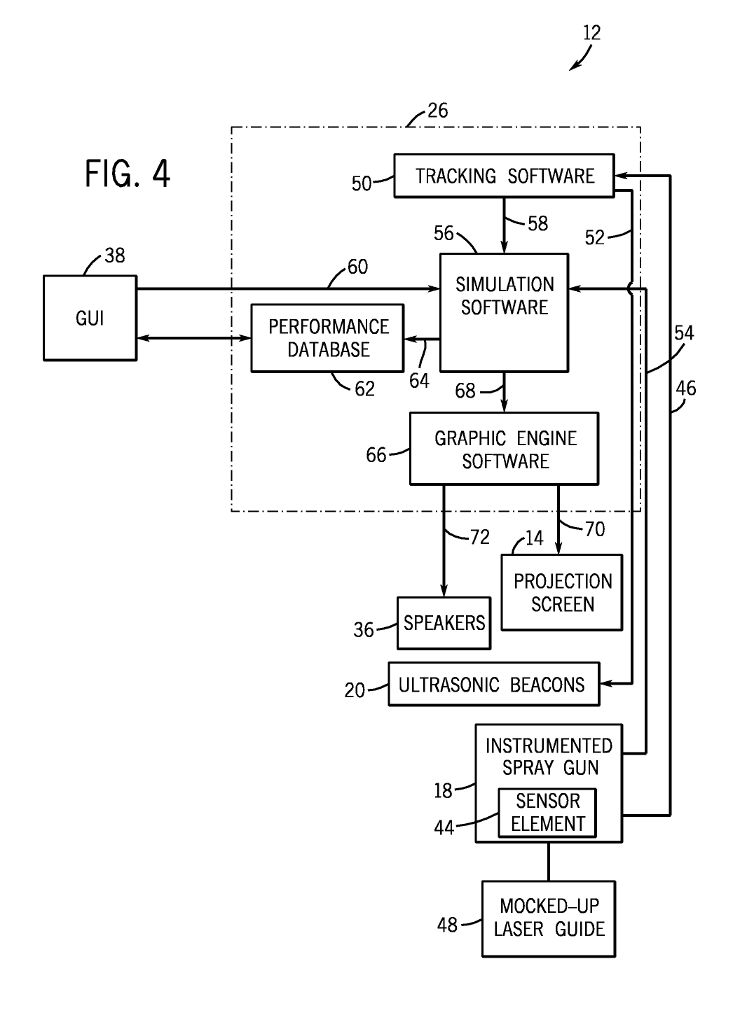

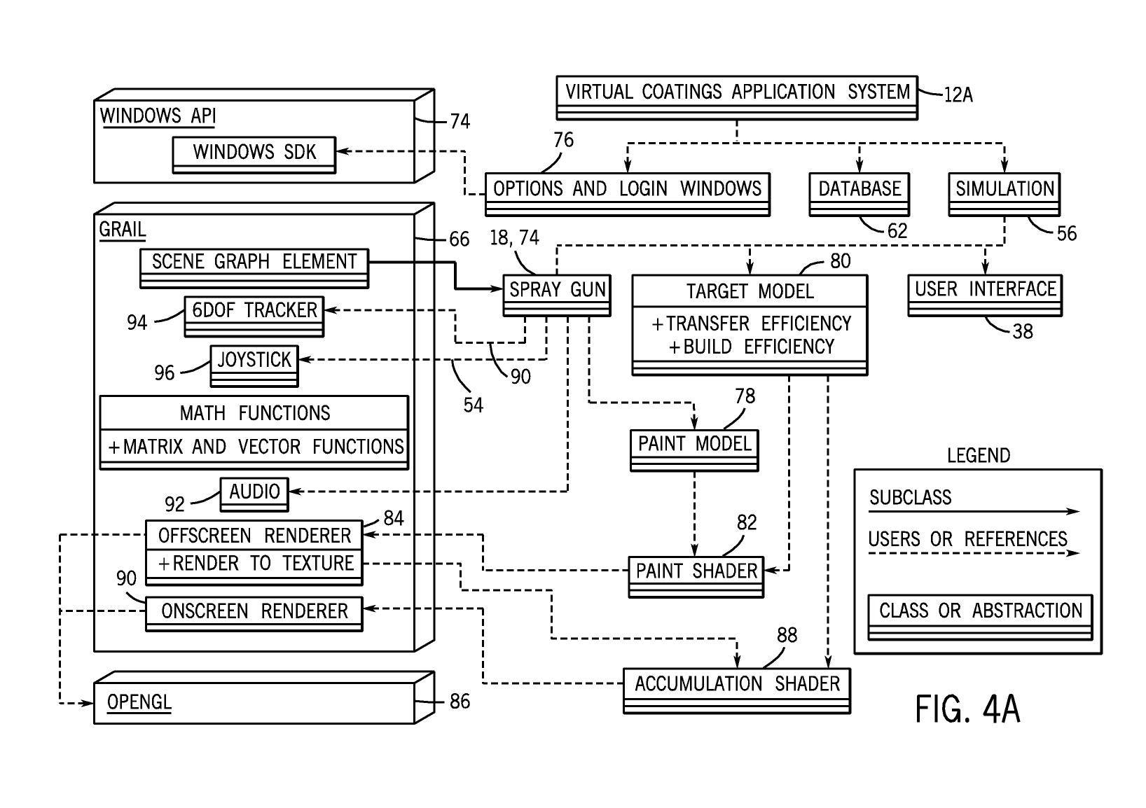

The airless spray gun controller 18 is connected to a computer 26 preferably via a USB cable connection 28. A monitor 30, keyboard 32 and mouse 34 are connected to the computer 26, as well as one or more loudspeakers 36, see, FIG. 4. The virtual coatings application system 12 includes a graphical user interface 38 that is displayed on the computer monitor 30.

FIGS. 2 and 3 show the preferred airless spray gun controller 18 in detail. The controller 18 is an actual airless spray gun that has been retrofitted so that an internal trigger switch provides an on/off signal via USB cable 28 to the computer 26. FIG. 3 illustrates a tip 41 being mounted to the spray gun controller 18, with a protective guard 42 being removed from the controller 18. Since the airless spray gun controller 18 is a retrofitted actual spray gun, the user can replace tip fittings 41 when desired, although tip fittings 41 do not form part of the electronic aspect of this invention. As is typical in the art, there is not a fluid control knob on the airless spray gun controller 18. Rather, the fluid pressure is adjusted on the graphical user interface 38, FIG. 1, on the computer to more closely simulate changing fluid pressure on a hydraulic pump on the floor.

The preferred airless spray gun controller 18 is instrumented with a hybrid inertial and acoustic sensor 44, which is mounted to the top surface of the controller 18. The preferred inertial and acoustic sensor 44 is supplied along with other components of the tracking system from Intersense, Inc. of Bedford, Mass. The preferred sensor is the Intersense IS-900 PC Tracker Device. The sensor includes accelerometers and gyroscopes for inertial measurement and a microphone for measuring ultrasonic signals from the series of ultrasonic transmitters 20, see FIG. 1. The preferred arrangement of ultrasonic transmitters consist of a Soniframe™ emitter with two six foot Sonistrip™ and one four foot Sonistrip™ from Intersense, and provides tracking volume of approximately 2 meters×2 meters×3 meters for the virtual workspace 24 although other configurations can exist such as mounting three four foot Sonistrip™ in front of the user around the screen. The ultrasonic transmitters 20 receive timing signals from tracking software in the computer 26. The sensor microphone detects high frequency signals from the ultrasonic transmitters 20, and the sensor accelerometers and gyroscope devices generate inertial position and orientation data. Inertial measurements provide smooth and responsive sensing of motion, but accumulation of noise in the signals can cause drift. The ultrasonic measurements are used to correct such drift. The sensor 44 located on the spray gun controller 18 receives an ultrasonic signals, namely x, y, z for linear directions. The signals from the sensor 44 are transmitted to a cable 46 which is fed through a hose to the computer 26 via a hub for the tracking system. The position and orientation of the sensor 44 is determined based on the software in the computer 26, thus determining the position and orientation of the airless spray gun controller 18 in a virtual workspace 24 in front of the display screen surface 16. While it is possible for the connections from the spray gun controller 18 to the computer 26 to be wireless connections, it is preferred that a hose 28 be used to house cables in order to simulate the paint supply hose feeding an actual spray gun.

While FIG. 2 does not show a laser targeting and positioning system mounted to the housing of the spray gun controller 18, a laser or light beam targeting and positioning system can be simulated, for example, via a reverse projection display method, as described in the above co-pending patent application Ser. No. 11/372,714. Actual laser guide systems as described in U.S. Pat. Nos. 5,598,972; 5,857,625 and 5,868,840 all assigned to the assignee of the present application, and incorporated herein by reference, use a reference light beam projecting forward from the spray gun onto the surface being painted and a non-parallel guide beam which also projects onto the surface being painted. The user of the spray gun aims the center of the spray at the spot illuminated by the reference beam, and determines whether the spray gun is at the appropriate orientation standoff distance from the surface using both illuminated points and determining whether the points have converged or are aligned. In the preferred embodiment of the invention, software within the computer 26 models illumination of the spots on the virtual surface 16. If desired, an actual laser guide or a mock-up can be mounted on the controller 18.

FIG. 4 is an overall block diagram showing components of a virtual coatings application system 12 and the flow of application data between the various hardware and software components. Software for the virtual coatings application system 12 operating on the computer 26, FIG. 4, controls the operation of the system 12. Block 50 in FIG. 4 depicts the tracking software loaded on the computer 26. The preferred tracking software, as mentioned earlier, is provided by Intersense, Inc. of Bedford, Mass. The tracking software outputs signals to the ultrasonic beacons 20 as shown by line 52. The ultrasonic beacons transmit ultrasonic signals that are detected by the sensor element 44 on the airless spray gun controller 18. The sensor element 44, as mentioned previously, also includes inertial sensor elements. The airless spray gun controller 18, and in particular the tracking sensor element 44, sends six degree of freedom tracking data to the tracking software via line 54. The Intersense tracking system has a positional resolution of 0.75 mm and an orientation resolution of 0.05°, a static accuracy for position RMS of 2.0 mm-3.0 mm, a static accuracy for orientation RMS of 0.25° for pitch and roll, and 0.50° for yaw. The interface update rate is 100-130 Hz, and the minimum latency of 4 milliseconds is typical.

Based on the six degree of freedom signal that is transmitted to the tracking software via line 54, the tracking software 50 outputs position and orientation data to simulation software 56. As described in more detail in U.S. Pat. No. 6,176,837, incorporated herein by reference, the tracking software 50 determines the position and orientation data with advanced Kahlman filter algorithms that combine the output of the inertial sensors with range measurements obtained from the ultrasonic components. Arrow 58 depicts the six degree of freedom position and orientation data being sent from the tracking software 50 to the simulation software 56. The simulation software 56 also receives a signal in line 54 from the on/off switch in the airless spray gun controller 18, as well as information from the graphical user interface 38, see arrow 60. In particular, data pertaining to training setup parameters such as the selected tip size, the fluid pressure setting and the viscosity of the paint are set on the graphical user interface 38 and are transmitted to the simulation software 56, as depicted by arrow 60.

The simulation software 56 feeds calculated information to a performance database 62, see arrow 64, as well as to graphics engine software 66, see arrow 68. In practice, the preferred system actually involves several separate flows of information from the simulation software 56 to the graphical engine software 66 and the performance database 62. The graphic engine software 66 outputs data that drives images on the projection screen 14 (depicted by arrow 70) as well as data that drives loudspeakers 36 (depicted by arrow 72).

FIG. 4a depicts the software architecture of the system 12a. Referring to FIG. 4a, when the user 10 launches the virtual coatings application system software on the computer, the Windows® application programming interface 74 is launched to run the application software. Preferably, the user is required to log in, see reference number 76, before using the system. The system 12a generates a student performance data file for each student that has logged in on the system, and these student data files are stored as part of the performance database 62. Once the user 10 is logged in, the graphical user interface 38 appears on the computer screen 30, and performance data for that specific student is read from and written to the student data file and displayed on the computer screen for the graphical user interface 38.

Still referring to FIG. 4a, the simulation software 56 includes a paint model 78 that models the amount and pattern of paint virtually deposited on the virtual surface for each slice of time, as will be discussed in more detail below. The simulation software 56 also includes a target model 80 which models the two dimensional image to be displayed on the projection screen 16 as the virtual surface of the part being painted. In addition, in accordance with one aspect of the invention, the target model can also display a virtual image of non-absorbing practice paper. Preferably, the models for virtual painting surfaces are supplied in the 3D StudioMax (3DS) format. For two dimensional images, the models are flat along the z axis. Software can be developed for this application in the C++ programming language using Microsoft® Visual Studio®.

FIG. 4a shows that information from the paint model 78 and the target model 80 are sent to a paint shader module 82. The paint shader module 82 determines whether the pattern of virtual paint output by the paint model 80 for that timing cycle hits the surface of the two dimensional image (i.e., hits the virtual surface) that is modeled by the target model 80. If not, as mentioned, the software has the capability of illustrating paint overspray in a color different from the selected paint color. This information is also used to monitor performance. Output from the paint shader module 82 is sent to the graphics engine 66. The preferred graphics engine is a scene graph based rendering engine, and in particular, the GraIL™ graphics engine developed by and available from Southwest Research Institute, San Antonio, Tex. The output from the paint shader module 82 to the graphics engine software 66 is inputted to the offscreen renderer 84. The offscreen renderer 84 generates an image of only paint. The offscreen renderer 84 sends data to the open graphics library 86, which is part of the operating system and the industry standard application program interface for defining two dimensional and three dimensional images. The Open GL software is provided by Microsoft free of charge. The offscreen renderer 84 also supplies information to an accumulation shader module 88. The accumulation shader module 88 receives information from the target model 80 as well. The accumulation shader module 88 outputs information to the onscreen renderer 90 within the graphics engine software 66. The onscreen renderer 90 draws the target (i.e. the virtual surface) with virtual paint on it. The onscreen renderer is GraIL's normal rendering path. The onscreen renderer 90 outputs to the open graphics library 86 which controls the display on the projection screen 14.

The graphics engine 66 also includes an audio component 92. The airless spray gun controller 18 uses the audio component 92 to load and play audio, e.g. when the airless spray gun controller 18 is in the “on” position. In addition, the graphics engine 66 preferably includes support for the six degree of freedom tracking system as depicted by box 94 and support for receiving data regarding the trigger position of the spray gun controller, as depicted by box 96. In addition, the graphics engine software 66 includes matrix and vector libraries that are used to calculate positions, orientations, model transformations, intersections, projections, formats and other such datum.

As mentioned, the airless spray gun virtual coatings application system 12 as described herein can be implemented on a stand-alone basis, or can be implemented as a module in a system also supporting the simulation of a high volume, low pressure (HVLP) spray gun, simulation of a blasting nozzle, and/or simulation of another type of spray gun technology. In this regard, reference should be made to previously mentioned co-pending patent application Ser. No. 11/372,714 filed on Mar. 10, 2006, and application Ser. No. 11/539,352 filed on Oct. 6, 2006 both entitled “Virtual Coatings Application System”; application Ser. No. 11/563,842 filed on Nov. 28, 2006, entitled “Virtual Coatings Application System with Structured Training and Remote Instructor Capabilities” which have previously been incorporated herein by reference, as well as application Ser. No. 12/028,917, filed on Feb. 11, 2008, entitled “Virtual Blasting System for Removal of Coating and/or Rust from a Virtual Surface”, which is describes a blasting simulation system and is also incorporated herein as reference. Note that other features in these incorporated co-pending patent applications may be useful in connection with the airless spray gun simulation and are preferably implemented whether the airless spray gun system 12 is implemented in stand-alone form or as a module for a system also simulating other types of spray guns and/or blasting nozzles. However, in order to simulate an airless spray gun realistically, the setup parameters and the paint model are quite different than what is necessary for simulating an HVLP spray gun or a blasting nozzle.

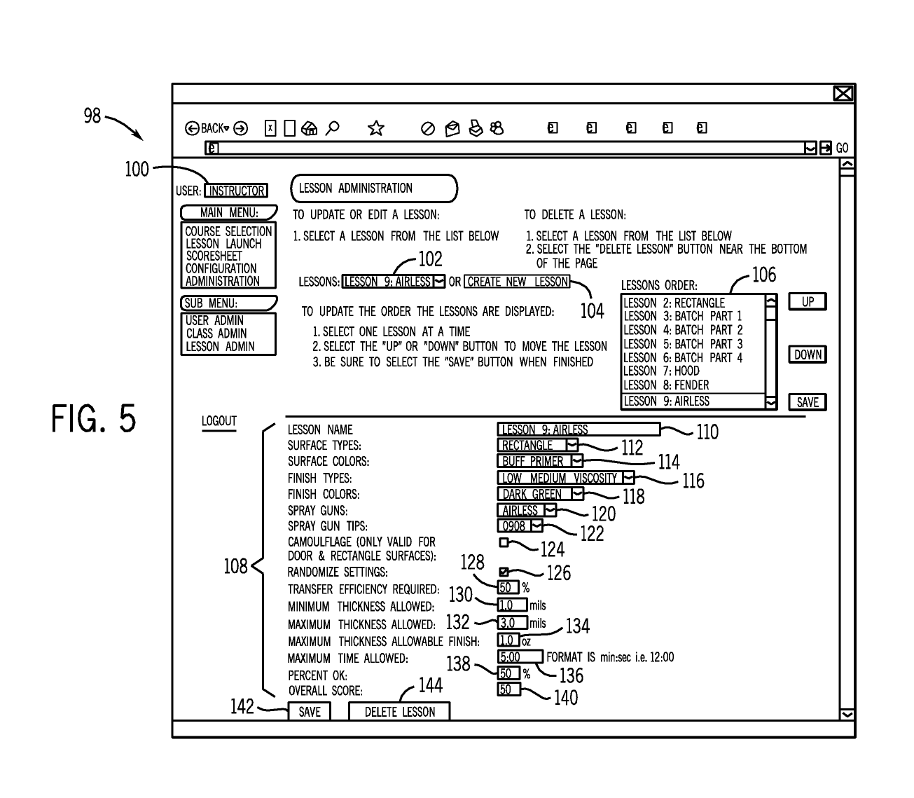

FIG. 5 shows a lesson administration screen 98 which is accessible to an instructor 100 to develop a lesson on airless spray painting for students to use at a later time. The screen 98 allows the instructor to edit an old lesson or create a new lesson as indicated by prompts 102, 104 and lesson menu 106. If the instructor chooses to edit an existing airless lesson, as was done in FIG. 5, or chooses to create a new lesson, prompts 108 appear on the screen 98 for the instructor to program. Prompt 110 asks the instructor to add or edit the lesson name. Prompt 112 requests the instructor to enter the shape of the surface being virtually coated. Prompt 114 requests the instructor to enter the initial color of the virtual surface being coated. Prompt 120 requests the instructor to enter the type of spray gun that will be simulated. In FIG. 5, an airless spray gun has been chosen. When the invention is implemented with other modules simulating HVLP spray guns and/or blasting nozzles, the instructor will have the choice to choose either an HVLP spray gun and/or a blasting nozzle in addition to an airless spray gun. As mentioned above, the setup parameters are different depending on the spray gun selected by prompt 120 and therefore the prompts 108 will change if other simulations are selected. When the airless spray gun is selected to be simulated at prompt 120, prompt 116 requests the instructor to enter the type of the finish, namely whether it is low viscosity or medium viscosity. The preferred embodiment of the invention does not model high viscosity paint, although doing so is contemplated within the scope of the invention. Prompt 118 requests the instructor to enter the finish color.

Prompt 122 requests the instructor to enter the spray gun tip size. At prompt 122, there are several preselected tip sizes that the instructor may choose from. The preferred list of spray gun tip sizes, as mentioned above, is: 0908, 0912, 1110, 1112, 1114, 1308, 1312, 1314, 1510, 1514, 1712, and 1914. As described hereinafter, empirical data was gathered for spray coverage patterns and build thickness rate at various fluid pressures and standoff distances for the listed tip sizes.

Prompt 124 allows the instructor to select whether or not the camouflage feature is enabled. The camouflage feature is described in detail in co-pending patent application Ser. No. 11/539,352 which has been incorporated herein by reference. Prompt 126 allows the instructor to select whether to randomize settings. If the airless spray gun simulation is chosen via prompt 120, a random value will be generated for fluid pressure if the instructor selects the randomized setting feature. If the HVLP spray gun simulation is selected at prompt 120, the randomize setting feature will generate random values for fan size, maximum flow rate and air pressure.

At prompt 128 in FIG. 5, the instructor enters the minimum transfer efficiency required to pass the lesson. Transfer efficiency is calculated as the mass of the finish deposited on the virtual surface divided by the mass of the finish sprayed (multiplied by 100). Prompt 130 and 132 requests the instructor to input the minimum and maximum mil thicknesses, respectively, for the lesson. The percent OK prompt 138 allows the instructor to enter the percent of the finished surface area that has a mil thickness falling between the minimum mil thickness and the maximum mil thickness. Prompt 134 requests the instructor to enter the maximum allowable amount of finish to be applied during the lesson. Prompt 136 provides a maximum allowable time for the student to complete the lesson in order to obtain a passing grade. The overall score prompt 140 is the minimum score necessary to obtain a passing grade. The overall score is preferably calculated according to the following equation: overall score=30%×(Transfer Efficiency)+70%×(% OK), although the weighting between the (Transfer Efficiency) and the (% OK) can be modified if desired.

Still referring to FIG. 5, the instructor uses the save button 142 to save the lesson and the delete button 144 to delete the lesson.

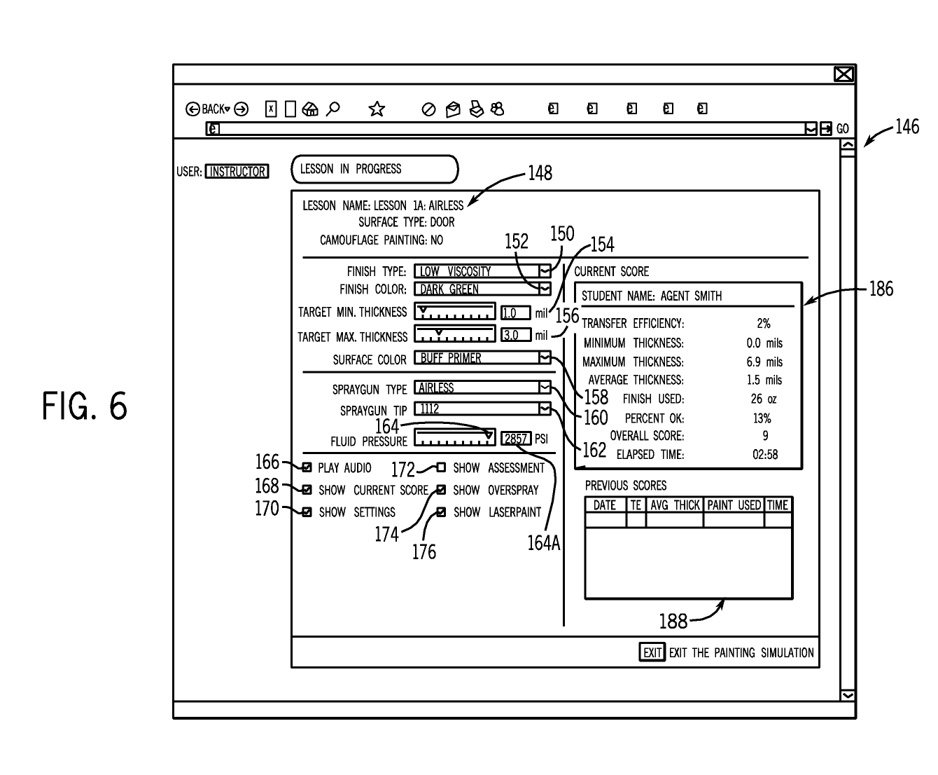

FIG. 6 shows the lesson-in-progress screen 146 which is available to the student when the student is taking a lesson or in free play mode. FIG. 6 shows that the student is taking a lesson, see arrow 148. The lesson shown in FIG. 6 is an airless lesson set up for the student to paint a door without camouflage. The finish type 150, finish color 152, minimum target mil thickness 154, maximum target mil thickness 156, surface color 158 and spray gun type 160 and spray gun tip 162 have been preset by the instructor in the lesson administration screen 98 of FIG. 5. If the student were in free play mode, the student would be able to change the parameters entered in prompts 150, 152, 154, 156, 158, 160 and 162.

A slide 164 is provided on the screen 146 to adjust virtual paint fluid pressure. The student is able to change the virtual fluid pressure during the course of a lesson or in free play mode. Note that it is preferred that the slide 164 include a digital readout 164a.

The lesson-in-progress screen 146 on the graphical user interface 38 also includes several toggle switches which allow activation of various features. The box 166 labeled “Play Audio” allows the user to determine whether the simulation will include simulated operating noise in accordance with data from the audio component 92 in the simulation software. In this regard, the system 12 includes one or more loudspeakers 36 and the software interactively generates an output sound in response to whether the trigger on the airless spray gun controller 18 has been activated. The output sound signals are provided in real time to drive one or more loudspeakers to simulate the sound of a an operating airless spray gun controller 18. The simulation software includes digital sound files of actual noise recordings of an airless spray gun controller.

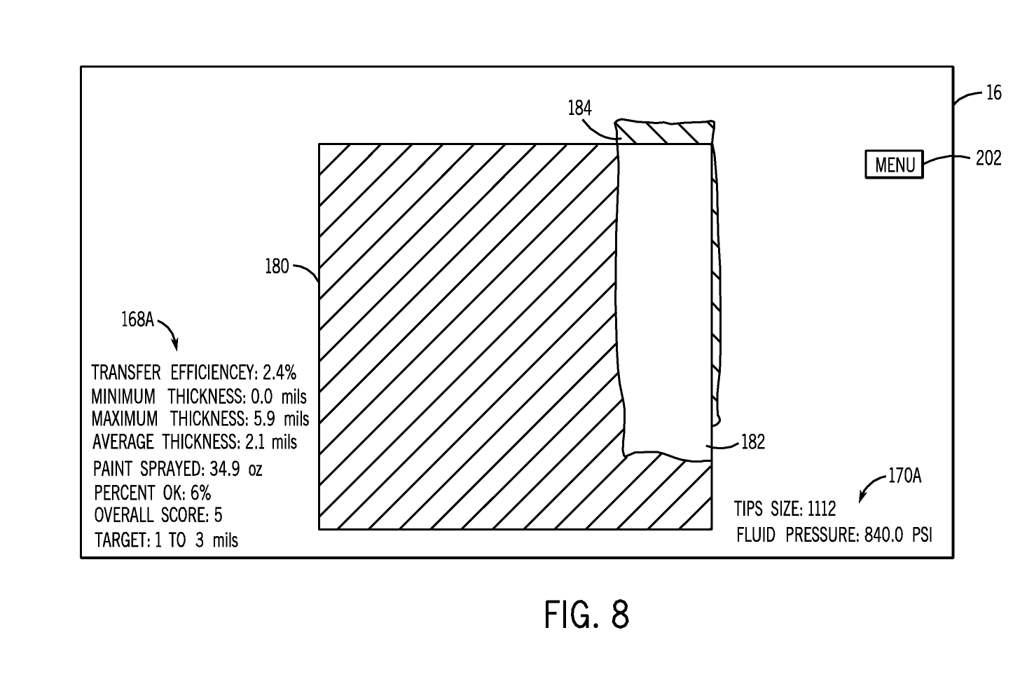

The box 168 entitled “Show Current Score” enables the student to choose whether performance data for the session such as transfer efficiency, minimum thickness, maximum thickness, average thickness, total amount of paint sprayed, percent OK, and overall score, are displayed on the screen 16 along with the virtual images. Box 170 entitled “Show Settings”, likewise, allows the user to choose whether current controller settings, such as tip size and fluid pressure, are displayed on the projection screen 16. Note that FIG. 8 shows a display screen 16 in which a virtual surface is displayed along with the current score 168a for the session and the current settings 170a.

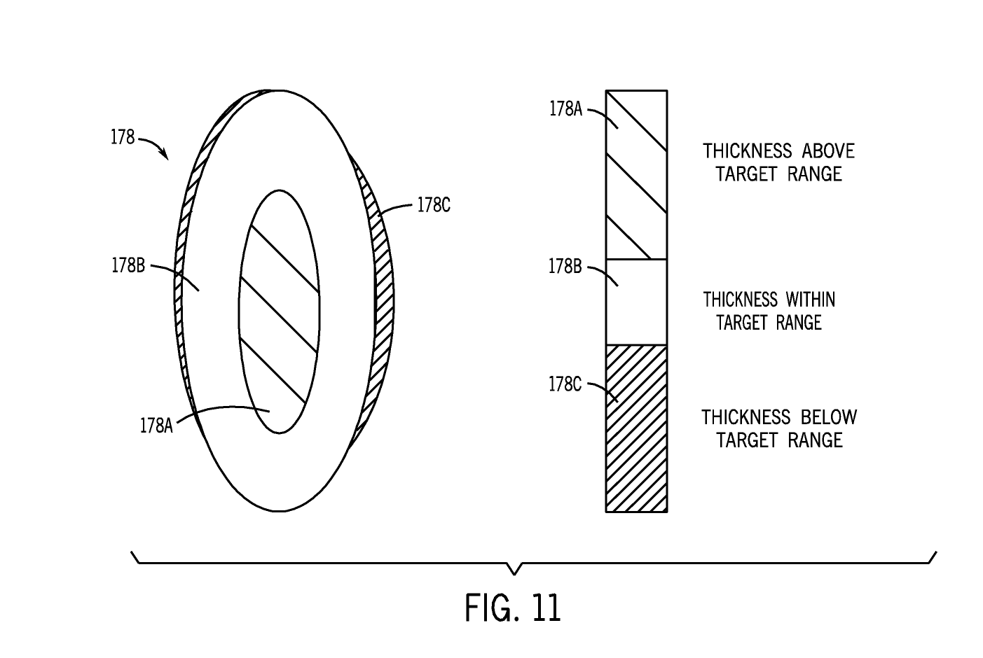

Box 172 in FIG. 6 entitled “Show Assessment” allows the user to choose whether accumulated build thickness is displayed in single color mode or in a multiple color assessment mode. FIG. 11 illustrates the assessment mode. The pattern 178 shown in FIG. 11 shows three regions 178a, 178b, 178c, each represented by a different color. The middle region is preferably illustrated in the color red, and represents a coating thickness above the target range, e.g., above 3 mil set at prompt 156 in FIG. 6. The intermediate region 178b is preferably displayed in green and represents the region in which the thickness is within the target range, e.g. between the 1 mil minimum thickness target set in prompt 154 in FIG. 6 and the 3 mil maximum thickness target set by prompt 156. The outermost region 178c is preferably displayed the color blue, and represents coating thicknesses below the minimum target range, e.g. below the 1 mil minimum target value set at prompt 154 in FIG. 6. When the show assessment checkbox 172 is checked in FIG. 6, the surface color, e.g. set by prompt 158 in FIG. 6, is used to represent areas with no virtual paint. Shades of blue, 178c, FIG. 11, represent paint thickness under the target thickness, shades of green, 178b, represent paint thickness within the target range, and shades of red, 178a, represent thickness levels that exceed the target. The assessment display is created using the accumulation shader 88, FIG. 4a. The accumulation shader is a *.cg file. Note that the user can virtually paint the part on the display screen 16 without being in assessment mode, and can then change the settings to show the assessment mode on the display screen 16.

Box 174 in FIG. 6 entitled “Show Overspray” enables the user to choose whether to indicate virtual overspray on the display screen 16. Referring now to FIG. 8, a virtual two dimensional part 180 is shown on the display screen 16. The virtual surface 180 shown in FIG. 8 is a two dimensional rectangle. Typically, the initial color of the part is a solid color, set by prompt 158 in FIG. 6, e.g. buff primer in the embodiment illustrated. Using the airless spray gun controller 18, the user virtually applies paint to the part 180. The accumulated paint on the part 180 is depicted by region 182. The region labeled 184 in FIG. 8 depicts overspray, that is regions in which the spray pattern missed the part 180 being virtually painted. When the user chooses to show overspray on the display screen by checking box 174 in the lesson-in-progress screen 146 on the graphical user interface, overspray (region 184) is displayed as well as accumulation (region 182) of virtual paint on the virtual surface of the part 180. Preferably, overspray 184 is depicted in a color (preferably red) different than the color of the initial part 180 and also different than the color of the accumulated paint 182 on the part 180.

The lesson-in-progress screen 146 in FIG. 6 also shows a box entitled “Show Laser Paint”. This box 176 enables the user to select whether the simulation software should model a light beam or laser targeting and positioning system by illuminating two dots on the screen 16, thus helping the user position the virtual gun on the virtual surface and maintain the spray gun controller 18 at an appropriate standoff distance from the virtual surface and at the appropriate orientation. As mentioned above and in the incorporated patent application Ser. No. 11/372,714, the software generates data to illuminate an image on the projection screen 16 simulating a reference beam hitting a painted surface as well as the image on the display screen 16 of a gauge beam illuminating a spot on the surface. The image for the reference beam is preferably set to be in the center of the virtual spray pattern, whereas the image for the gauge beam depends on the standoff distance and orientation of the spray gun controller 18 with respect to the screen surface 16. Preferably, the image of the reference beam and the image of the gauge beam will converge to a single point at the middle of the spray pattern when the spray gun controller 18 is located at the appropriate distance and orientations with respect to the virtual surface 16. However, the image of the gauge beam on the display screen will depart from the image for the reference beam if the airless spray gun controller 18 is moved too far or too close to the surface 16 or tilted inappropriately. Since the standoff distance between the spray gun controller 18 and the display screen 16 is known by the tracking system, as well as the offset between the sources of the imaginary reference beam and the imaginary gauge beam and the angle of incident of the imaginary gauge beam with respect to the imaginary reference beam (via assumed default settings), the system can easily calculate the location of the illuminated images for the imaginary reference beam and the imaginary gauge beam on the surface 16 using fundamental trigonomic expressions.

In addition, as previously mentioned, the lesson-in-progress screen 146 on the graphical user interface 38 shown in FIG. 6 also displays one or more performance monitoring statistics for the current training session, as well as data summaries for previous training sessions. Display box 186 on screen 146 displays the following information for the current training session: transfer efficiency, minimum thickness, maximum thickness, average thickness, finished use, percent OK, overall score and elapsed time. A description of the definition and calculation of values for each of these performance metrics is listed below in Table 1, as previously disclosed in the above incorporated patent application Ser. No. 11/563,842, entitled “Virtual Coatings Application System With Structured Training And Remote Instructor Capabilities”

TABLE 1
Metric Descriptions

| Metric Name | Description |
|---|---|
| Transfer Efficiency (%) | MassFinishDeposited |
| | MassFinishSprayed |
| Average Mil Thickness | Average thickness of paint over entire surface |
| Minimum Mil Thickness | Smallest thickness value on surface |
| Maximum Mil Thickness | Largest thickness value on surface |
| Paint Used (oz.) | Total finish sprayed from gun |
| Elapsed Time (mm:ss) | Total lime of lesson |
| Percent OK (%) | Percentage of surface area that has a paint |
| | thickness that falls between the Minimum |
| | Mil Thickness and Maximum Mil Thickness |
| Overall Score | OverallScore − (30%) × (TransferEfficiency) + |
| | (70%) × (Percent OK) |

Box 188 on the lesson-in-progress screen 146 of the graphical user interface 38 in FIG. 6 shows summaries of previous performance scores for the logged-in user. This performance data is stored and recalled using the performance database 62, as previously discussed.

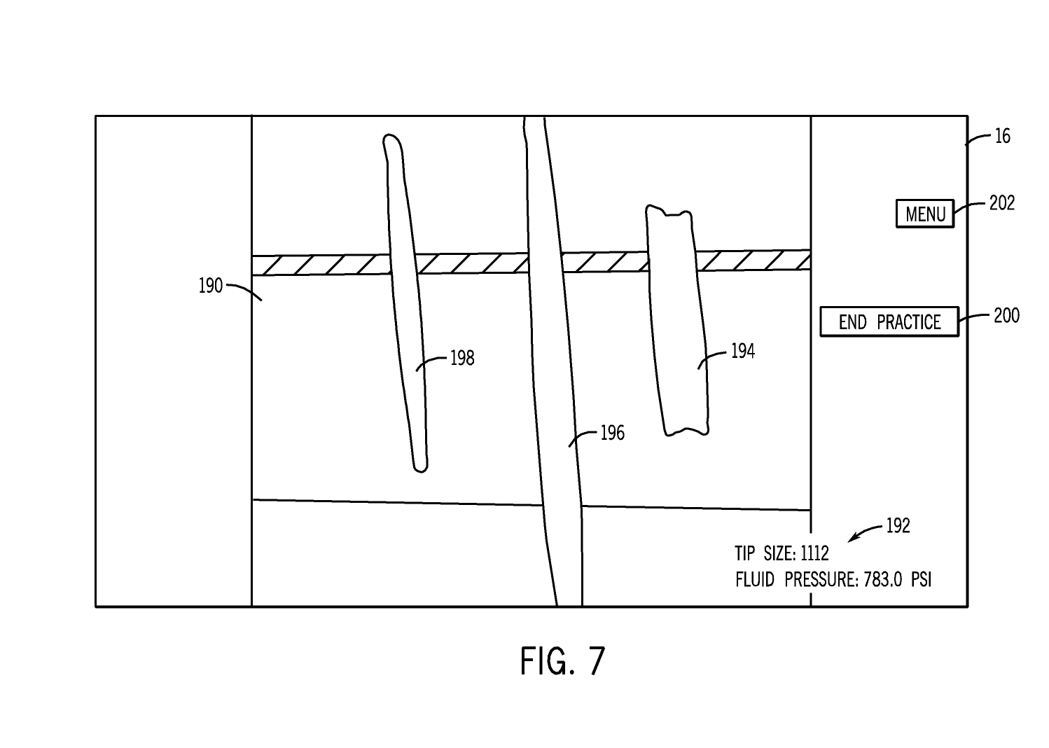

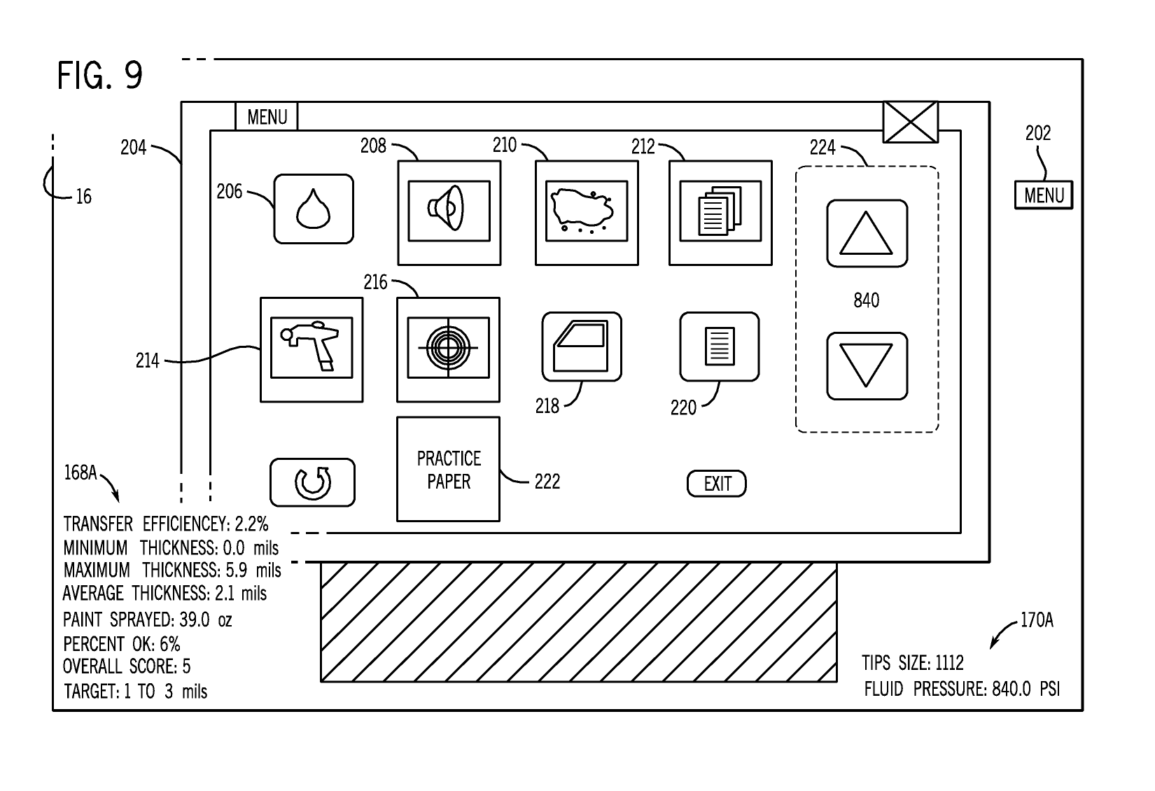

Referring now to FIG. 7, the preferred system 12 allows the student to practice painting either before entering the training mode to take a lesson or during a break at any time when in free play mode. During a practice session, virtual practice paper 190 is displayed on the screen display 16 as a target for the virtual paint. The virtual practice paper 190 is displayed to have characteristics and coloring similar to typical non-absorbent practice paper that is often available in spray paint booths. During the practice session, the training setup parameters 192 of tip size and fluid pressure are displayed on the screen. The student can practice virtual painting on the virtual practice paper at various standoff distances. In FIG. 7, three regions have been virtually painted, namely, regions 194, 196 and 198. Region 198 illustrates a pattern that is typical of an airless spray gun when it is at the appropriate standoff distance, whereas area 196 illustrates a pattern that is made at a further standoff distance such as 18 inches, and pattern 194 illustrates a pattern that may have been made at a closer standoff distance. Button 200 can be activated by the user using the airless spray gun controller 18 by pointing the controller at the button 200 and depressing the trigger in order to end the practice session. The screen shown in FIG. 7 also includes a menu icon 202 which can be activated in order to pull up a popup menu, as shown in FIG. 9.

Referring to FIG. 9, when activated, popup menu 204 is displayed on the display screen 16 on which the virtual surface normally appears. Popup menu 204 contains several icons 206, 208, 210, 212, 214, 216, 218, 220, and 222 that can be activated by the user by pointing the controller 18 at the icon on the screen and pulling the trigger on the controller 18. The icons allow the user to adjust system setup parameters or operation mode, or select features without stopping a simulation session to make changes on the graphical user interface 38. The finish color icon 206 allows the user to adjust finish color. The audio icon 208 allows the user to turn on or off the audio feature. Icon 210 allows the user to select whether to display overspray. Icon 212 allows the user to select whether current scores, 168a in FIGS. 8 and 9, will be displayed on the virtual surface display screen 16. Icon 214 allows the user to change controller settings, namely, tip size when an airless spray gun is being simulated. Icon 216 allows the user to turn on or off the laser guide feature. Icon 218 allows the user to turn on or off the assessment mode. Icon 220 allows the user to access instructions written up by the instructor for the lesson. Icon 222 allows the student to start a practice session with the virtual practice paper. The electronic dial 224 allows the user to change the paint fluid pressure without using the graphical user interface 38. The fluid pressure can be increased in increments of 100 psi by using either the up or the down arrow of the dial 224.

The paint model 78 in the simulation software simulates the flow and transfer of finishing material (e.g. paint) based on tip size, fluid pressure, and standoff distance of the airless spray gun controller 18 relative to the virtual surface 16. To do this, it was necessary to model the amount of virtual paint flow through the airless spray gun controller 18. Table 2 lists empirically obtained data regarding flow rate in gallons per minute and transfer efficiency for an airless spray gun based on various tip sizes, fluid pressures and standoff distances.

TABLE 2
Flow Rate and Transfer Efficiency Data

| Tip Size | Fluid Pressure (psi) | Dist (in) | TE (%) | Flow Rate (gal/min) |
|---|---|---|---|---|
| 908 | 750 | 4 | 95 | 0.039 |
| | 750 | 8 | 92 | |
| | 750 | 12 | 91 | |
| | 750 | 16 | 89 | |
| 912 | 750 | 4 | 95 | 0.039 |
| | 750 | 8 | 93 | |
| | 750 | 12 | 91 | |
| | 750 | 16 | 89 | |
| 1110 | 750 | 4 | 95 | 0.06 |
| | 750 | 8 | 93 | |
| | 750 | 12 | 91 | |
| | 750 | 16 | 89 | |
| 1112 | 750 | 4 | 95 | 0.06 |
| | 750 | 8 | 93 | |
| | 750 | 12 | 91 | |
| | 750 | 16 | 89 | |
| 1114 | 750 | 4 | 95 | 0.06 |
| | 750 | 8 | 93 | |
| | 750 | 12 | 91 | |
| | 750 | 16 | 89 | |
| 1308 | 750 | 4 | 95 | 0.09 |
| | 750 | 8 | 92.5 | |
| | 750 | 12 | 90 | |
| | 750 | 16 | 87.5 | |
| 1312 | 750 | 4 | 95 | 0.09 |
| | 750 | 8 | 92.5 | |
| | 750 | 12 | 90 | |
| | 750 | 16 | 87.5 | |
| 1314 | 750 | 4 | 95 | 0.09 |
| | 750 | 8 | 92.5 | |
| | 750 | 12 | 90 | |
| | 750 | 16 | 87.5 | |
| 1510 | 750 | 4 | 95 | 0.12 |
| | 750 | 8 | 92.5 | |
| | 750 | 12 | 90 | |
| | 750 | 16 | 87.5 | |
| 1514 | 750 | 4 | 95 | 0.12 |
| | 750 | 8 | 92.5 | |
| | 750 | 12 | 90 | |
| | 750 | 16 | 87.5 | |
| 1712 | 750 | 4 | 94 | 0.16 |
| | 750 | 8 | 91 | |
| | 750 | 12 | 88 | |
| | 750 | 16 | 85 | |
| 1914 | 750 | 4 | 94 | 0.19 |
| | 750 | 8 | 91 | |
| | 750 | 12 | 88 | |
| | 750 | 16 | 85 | |
| 908 | 1500 | 4 | 95 | 0.063 |
| | 1500 | 8 | 91 | |
| | 1500 | 12 | 87 | |
| | 1500 | 16 | 83 | |
| 912 | 1500 | 4 | 95 | 0.063 |
| | 1500 | 8 | 91 | |
| | 1500 | 12 | 87 | |
| | 1500 | 16 | 83 | |
| 1110 | 1500 | 4 | 95 | 0.095 |
| | 1500 | 8 | 91 | |
| | 1500 | 12 | 87 | |
| | 1500 | 16 | 83 | |
| 1112 | 1500 | 4 | 95 | 0.095 |
| | 1500 | 8 | 91 | |
| | 1500 | 12 | 87 | |
| | 1500 | 16 | 83 | |
| 1114 | 1500 | 4 | 95 | 0.095 |
| | 1500 | 8 | 91 | |
| | 1500 | 12 | 87 | |
| | 1500 | 16 | 83 | |
| 1308 | 1500 | 4 | 95 | 0.135 |
| | 1500 | 8 | 90 | |
| | 1500 | 12 | 85 | |
| | 1500 | 16 | 80 | |
| 1312 | 1500 | 4 | 95 | 0.135 |
| | 1500 | 8 | 90 | |
| | 1500 | 12 | 85 | |
| | 1500 | 16 | 80 | |
| 1314 | 1500 | 4 | 95 | 0.135 |
| | 1500 | 8 | 90 | |
| | 1500 | 12 | 85 | |
| | 1500 | 16 | 80 | |
| 1510 | 1500 | 4 | 95 | 0.18 |
| | 1500 | 8 | 90 | |
| | 1500 | 12 | 85 | |
| | 1500 | 16 | 80 | |
| 1514 | 1500 | 4 | 95 | 0.18 |
| | 1500 | 8 | 90 | |
| | 1500 | 12 | 85 | |
| | 1500 | 16 | 80 | |
| 1712 | 1500 | 4 | 93 | 0.235 |
| | 1500 | 8 | 87 | |
| | 1500 | 12 | 81 | |
| | 1500 | 16 | 75 | |
| 1914 | 1500 | 4 | 93 | 0.29 |
| | 1500 | 8 | 87 | |
| | 1500 | 12 | 81 | |
| | 1500 | 16 | 75 | |
| 908 | 2250 | 4 | 92 | 0.087 |
| | 2250 | 8 | 88 | |
| | 2250 | 12 | 84 | |
| | 2250 | 16 | 80 | |
| 912 | 2250 | 4 | 92 | 0.087 |
| | 2250 | 8 | 88 | |
| | 2250 | 12 | 84 | |
| | 2250 | 16 | 80 | |
| 1110 | 2250 | 4 | 92 | 0.13 |
| | 2250 | 8 | 88 | |
| | 2250 | 12 | 84 | |
| | 2250 | 16 | 80 | |
| 1112 | 2250 | 4 | 92 | 0.13 |
| | 2250 | 8 | 88 | |
| | 2250 | 12 | 84 | |
| | 2250 | 16 | 80 | |
| 1114 | 2250 | 4 | 92 | 0.13 |
| | 2250 | 8 | 88 | |
| | 2250 | 12 | 84 | |
| | 2250 | 16 | 80 | |
| 1308 | 2250 | 4 | 92 | 0.18 |
| | 2250 | 8 | 87 | |
| | 2250 | 12 | 82 | |
| | 2250 | 16 | 77 | |
| 1312 | 2250 | 4 | 92 | 0.18 |
| | 2250 | 8 | 87 | |
| | 2250 | 12 | 82 | |
| | 2250 | 16 | 77 | |
| 1314 | 2250 | 4 | 92 | 0.18 |
| | 2250 | 8 | 87 | |
| | 2250 | 12 | 82 | |
| | 2250 | 16 | 77 | |
| 1510 | 2250 | 4 | 92 | 0.24 |
| | 2250 | 8 | 87 | |
| | 2250 | 12 | 82 | |
| | 2250 | 16 | 77 | |
| 1514 | 2250 | 4 | 92 | 0.24 |
| | 2250 | 8 | 87 | |
| | 2250 | 12 | 82 | |
| | 2250 | 16 | 77 | |
| 1712 | 2250 | 4 | 90 | 0.31 |
| | 2250 | 8 | 83.5 | |
| | 2250 | 12 | 77 | |
| | 2250 | 16 | 70.5 | |
| 1914 | 2250 | 4 | 90 | 0.39 |
| | 2250 | 8 | 83.5 | |
| | 2250 | 12 | 77 | |
| | 2250 | 16 | 70.5 | |
| 908 | 3000 | 4 | 88 | 0.111 |
| | 3000 | 8 | 83 | |
| | 3000 | 12 | 78 | |
| | 3000 | 16 | 73 | |
| 912 | 3000 | 4 | 88 | 0.111 |
| | 3000 | 8 | 83 | |
| | 3000 | 12 | 78 | |
| | 3000 | 16 | 73 | |
| 1110 | 3000 | 4 | 88 | 0.165 |
| | 3000 | 8 | 83 | |
| | 3000 | 12 | 78 | |
| | 3000 | 16 | 73 | |
| 1112 | 3000 | 4 | 88 | 0.165 |
| | 3000 | 8 | 83 | |
| | 3000 | 12 | 78 | |
| | 3000 | 16 | 73 | |
| 1114 | 3000 | 4 | 88 | 0.165 |
| | 3000 | 8 | 83 | |
| | 3000 | 12 | 78 | |
| | 3000 | 16 | 73 | |
| 1308 | 3000 | 4 | 88 | 0.225 |
| | 3000 | 8 | 82 | |
| | 3000 | 12 | 76 | |
| | 3000 | 16 | 70 | |
| 1312 | 3000 | 4 | 88 | 0.225 |
| | 3000 | 8 | 82 | |
| | 3000 | 12 | 76 | |
| | 3000 | 16 | 70 | |
| 1314 | 3000 | 4 | 88 | 0.225 |
| | 3000 | 8 | 82 | |
| | 3000 | 12 | 76 | |
| | 3000 | 16 | 70 | |
| 1510 | 3000 | 4 | 88 | 0.3 |
| | 3000 | 8 | 82 | |
| | 3000 | 12 | 76 | |
| | 3000 | 16 | 70 | |
| 1514 | 3000 | 4 | 88 | 0.3 |
| | 3000 | 8 | 82 | |
| | 3000 | 12 | 76 | |
| | 3000 | 16 | 70 | |
| 1712 | 3000 | 4 | 85 | 0.385 |
| | 3000 | 8 | 78 | |
| | 3000 | 12 | 71 | |
| | 3000 | 16 | 64 | |
| 1914 | 3000 | 4 | 85 | 0.49 |
| | 3000 | 8 | 78 | |
| | 3000 | 12 | 71 | |
| | 3000 | 16 | 64 | |

The data is collected for each of the simulated tip sizes at a fluid pressure of 750 psi, 1500 psi, 2250 psi and 3000 psi. Note that the flow rate of virtual paint expelled from the spray gun does not vary with standoff distance variations, but the transfer efficiency of the paint onto the virtual surface does vary as a function of standoff distance. For each timing cycle, the mass of finish sprayed is determined using the values in Table 2 and interpolating for the current fluid pressure setting and standoff distance.

The paint model 78 models the distribution of the deposited finish over a virtual spray pattern based on data collected from spray patterns generated from actual airless spray guns at various spray gun settings and standoff distances as well as the paint viscosity. In other words, the coverage pattern varies with respect to tip size, standoff distance, fluid pressure, and paint viscosity. In addition, the instantaneous coverage pattern on the virtual surface will change orientation with respect to the orientation of the spray gun controller 18.

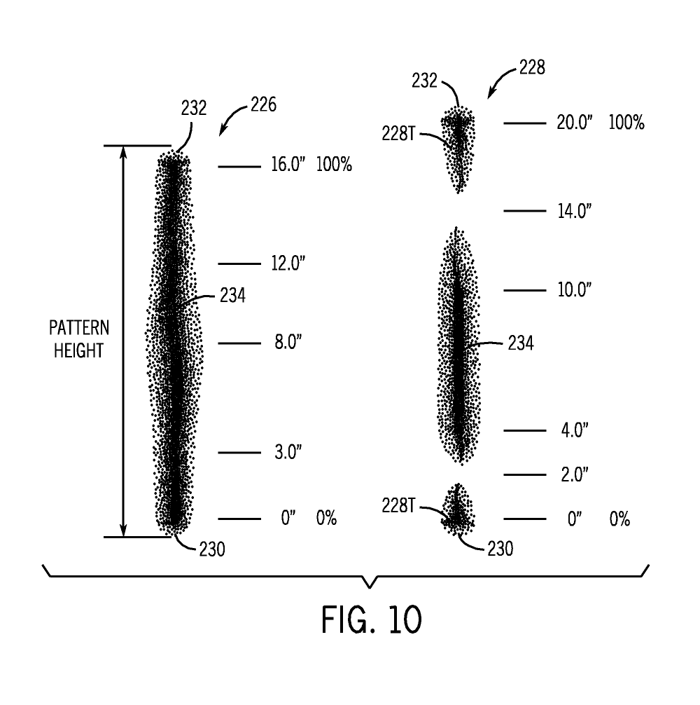

In general, the shape of the coverage pattern for particular combinations of tip sizes, paint fluid pressure and viscosity is independent of standoff distance until one of two things happen. Either the pattern degrades because the standoff distance is too large and the paint does not stick to the surface; or the pattern degrades because the standoff distance is too small and the paint buildup is too rapid. For mid to large standoff distances in the typical range for airless spray guns, a primary coverage pattern is generated which minimizes the effects of rapid buildup, or paint drying before it hits the target or changing trajectory due to gravity. With this in mind, each primary pattern is characterized in the data model by a series of data points. Referring to FIG. 10, the data points for each primary pattern include empirically determined values as selected y-axis distances from the bottom of the pattern upward to its highest point, pattern width at each point, and paint thickness at each point. Note that the pattern 226 in FIG. 10 shows y-axis data points at 0 inches, 3 inches, 8 inches, 12 inches, and 16 inches, which are chosen to provide representative data point to describe the pattern accurately and realistically. On the other hand, the pattern 228 in FIG. 10 includes tails 228T and therefore additional y-axis data points are used to identify lack of coverage in regions leading to the formation of the tails 228T. In 228T, the y axis data points are 0 inches, 2 inches, 4 inches, 10 inches, 14 inches and 20 inches. In order to support generation of patterns from interpolated values, sufficient data points should be defined at transitions in the pattern 226, 228 where the width and/or paint thickness experiences significant changes. The patterns 226, 228 are assumed to have a semicircular portion at the top end 232 and bottom end 230, and the thickness is assumed to fall off linearly in these end portions 230, 232. In addition, thickness is assumed to fall off linearly as the pattern extends outward from the centerline 234 of the pattern 226, 228.

As mentioned, data is recorded characterizing each empirically gathered pattern for various combinations of tip size, viscosity (preferably low and medium) and fluid pressure. For a given tip size and viscosity, when the actual pressure falls between two recorded patterns, overall height is interpolated for the two pressures nearest the pressure of interest. Pattern width and paint thickness are sampled in terms of pattern height percentage, and width and thickness at each height in the generated pattern are interpolated from these values. In this way, tails, e.g. 228T, naturally fade within increased fluid pressure settings and overall pattern height changes continuously and contiguously with changes in fluid pressure. The resulting full pattern is representative in terms of height and width for a specified standoff distance for which the data is recorded. Pattern size is adjusted for actual instantaneous standoff distance, and thickness applied per unit time at every pixel is adjusted via a typical square law calculation to correct for actual standoff.

Empirical analysis of actual airless spray gun patterns indicates that heavy flow rates at small standoff distances result in paint being pushed off the primary pattern. At small standoff distances, the force of the onrushing spray causes the primary pattern to degrade into a spreading elliptical pattern. In order to accurately simulate this phenomenon, the preferred embodiment of the invention models these elliptical patterns, and under appropriate conditions superimposes the elliptical patterns on the primary pattern. As standoff distance increases, the elliptical aspect of the patterns disappears. Therefore, data files for the paint model preferably define the elliptical pattern in terms of maximum height and width of the elliptical pattern, the standoff distance at which the elliptical pattern is maximum size, and the standoff distance at which the elliptical pattern disappears. The size of the elliptical pattern is preferably assumed to decrease linearly with increasing standoff distance.

It has been found that this method produces realistic approximations of recorded paint patterns which closely resemble actual patterns. It has been found that minor variations between the actual and generated patterns can be expected to be smaller than the motion experienced by the spray gun controller even when the operator is attempting to keep the spray gun controller motionless. Thus, minor variations will even out over time, resulting in little or no visible artifacts from the pattern generation process. Because the pattern is symmetric about the vertical axis, only half the pattern need be generated. The other half is preferably generated as a mirror of each data point generated, accelerating overall pattern generation.

For each timing cycle, the mass of finish sprayed is determined using the values in Table 2 and interpolating as necessary for fluid flow rate and transfer efficiency. The paint model 78 distributes the virtual mass of finish deposited (i.e. mass virtually sprayed scaled by the corresponding transfer efficiency value) over the spray pattern, which as described may consist of a primary pattern and an elliptical pattern, in accordance with the empirically collected data for spray gun controller settings, paint viscosity and standoff distance. The paint model 78 compensates for the rotation of the airless spray gun controller 18 by rotating the coverage pattern. In the preferred system, each location on the projection screen 16 on which the virtual surface is projected has an associated alpha channel. The alpha channel controls transparency of the coating at that location based on the mathematical accumulation of virtual spray at the given location, thus realistically simulating fade in for partial coverage on the virtual surface. Thus, depending on the tip size, paint viscosity, fluid pressure setting, as well as the standoff distance and orientation of the spray gun controller with respect to the virtual surface, the software maintains accumulation values at each location (via the alpha channel). The virtual paint on the workpiece is displayed according to the alpha channel information and the display or color mode selected by the user on the graphical user interface 38.

Those skilled in the art should appreciate that the embodiments of the invention disclosed herein are illustrative and not limiting. Since certain changes may be made without departing from the scope of the invention, it is intended that all matter contained in the above description shown in the accompanying drawings be interpreted as illustrative and not in a limiting sense.

We claim:

1. A virtual coatings application system comprising:
a display screen on which a virtual surface is displayed;
an instrumented spray gun controller simulating an airless spray gun outputting a signal representing whether the airless spray gun controller is in an on position or is in an off position;
means for inputting training session setup parameters into the system, wherein the training session setup parameters consist of one or more of the following:
tip size, paint fluid pressure, and paint viscosity;
a motion tracking system that tracks the position and orientation of the spray gun controller with respect to the virtual surface on the display screen; and
a computer programmed with software which generates virtual spray pattern data in response to at least the one or more training session setup parameters and the position and orientation data received from the tracking system;
wherein a virtual spray pattern image is displayed in real time on the display screen in accordance with the accumulation of virtual spray pattern data at each location on the virtual surface; and
wherein the software comprises a paint model that outputs virtual spray pattern data to characterize the resulting pattern of virtual spray as a function of time in response to standoff distance and angular orientation of the airless spray gun controller to the virtual surface on the display screen.

2. A virtual coatings application system as recited in claim 1 wherein the paint model is based in part on total virtual build thickness rate data which is determined as a function of the selected tip size and paint fluid pressure, and also the sensed standoff distance of the airless spray gun controller from the virtual surface on the screen display.

3. A virtual coatings application system as recited in claim 2 wherein the virtual build thickness rate data is adjusted by an empirically determined transfer efficiency for the selected tip size, paint fluid pressure and standoff distance.

4. A virtual coatings application system as recited in claim 1 which simulates coverage pattern and build thickness via a model derived from empirical data gathered from actual spray patterns from airless spray guns having a variety of tip sizes and fluid pressure settings.

5. A virtual coatings application system as recited in claim 4 wherein the model includes a primary pattern which comprises a series of data points representing linear distance along the pattern, pattern width at that point of the pattern, and pattern thickness at that point of the pattern.

6. A virtual coatings application system as recited in claim 5 wherein the thickness is assumed to fall off linearly as the pattern extends away from a centerline of the pattern lying along the series of data points.

7. A virtual coatings application system as recited in claim 5 wherein the ends of the pattern are assumed to be semicircular and the thickness is assumed to fall off linearly within the semicircular ends.

8. A virtual coatings application system as recited in claim 4 wherein the pattern is adjusted for instantaneous standoff distance and the thickness applied per unit time for each pixel on the virtual surface on the display is adjusted to account for the instantaneous standoff distance.

9. A virtual coatings application system as recited in claim 5 wherein the model includes a plurality of data points for various combinations of tip sizes and fluid pressure settings for which the pattern formed contains at least one tail.

10. A virtual coatings application system as recited in claim 4 wherein a first side of the pattern is calculated from the model and the other side of the pattern is a mirror image of the first side.

11. A virtual coatings application system as recited in claim 4 wherein interpolation and normalization are used to calculate the thickness applied per unit time per pixel for values between empirically derived data points.

12. A virtual coatings application system as recited in claim 5 wherein the model further comprises an elliptical pattern that is superimposed on the primary pattern, wherein the intensity of the elliptical pattern is determined as a function of standoff distance in order to simulate degradation of the primary pattern due to rapid buildup at reduced standoff distances.

13. A virtual coatings application system as recited in claim 1 wherein multiple colors are used to depict accumulation level ranges at a given location.

14. A virtual coatings application system comprising:
an instrumented spray gun controller;
a motion tracking system that tracks the position and orientation of the spray gun controller with respect to the virtual surface on the display screen;
a graphical user interface that allows the user to select training setup parameters;
a computer programmed with software having a paint model that generates virtual spray pattern data for each timing cycle, and wherein the computer and the software provides part image data for an image of a part to be displayed on the display screen defined on the virtual surface and allows the user to choose to display the image of the part on the screen defining the virtual surface of the part as a target for the user using the spray gun controller, and wherein the software also provides image data for virtual practice paper, wherein the user can choose to display the image of the virtual practice paper on the screen defining the virtual surface as the target for the user using the spray gun controller.

15. A virtual coatings application system as recited in claim 14 wherein the display screen includes one or more icons which can be toggled by pointing the spray gun controller and activating the trigger on the spray gun controller, wherein at least one of the icons is an icon prompting the user to select whether to display virtual practice paper on the display screen.

16. A virtual coatings application system as recited in claim 14 wherein the software further comprises a free play mode and a lesson mode, and the user can select to display the virtual practice paper on the screen display either before a training lesson or during free play mode.

17. A virtual coatings application system as recited in claim 16 wherein the lesson mode contains training curriculum in the form of at least one virtual painting lesson having minimum performance standards set for selected performance criteria.

18. A virtual coatings application system as recited in claim 14 wherein the spray gun controller is a controller simulating an airless spray gun.
